(19) United States
(12) Patent Application Publication
(10) Pub. No.: US 2021/0016210 A1
(43) Pub. Date: Jan. 21, 2021

(54) Filter Arrangement, Connection Interface Element and Filter Interface Unit

(71) Applicant: MANN+HUMMEL GmbH, Ludwigsburg (DE)

(72) Inventors: Alexander Meier, Speyer (DE); Michael Schulze, Speyer (DE); Dennis Stark, Mauer (DE); Duc Cuong Nguyen, Laatzen (DE)

(21) Appl. No.: 17/061,655

(22) Filed: Oct. 2, 2020

Related U.S. Application Data
(63) Continuation of application No. PCT/EP2019/058337, filed on Apr. 3, 2019.

(30) Foreign Application Priority Data
Apr. 4, 2018 (DE) 10 2018 002 766.0

(51) Int. Cl. B01D 35/143; B01D 46/00

(52) U.S. Cl. CPC B01D 35/143; B01D 46/009; B01D 2201/4046; B01D 2201/52; B01D 46/0005

(57) ABSTRACT

A filter arrangement with filter element for purifying a dielectric of a machine for electrical discharge machining has a dielectric inlet with a connector for connecting a dielectric feed connection element of the machine for electrical discharge machining. The filter arrangement has an adapter form fit element that connects detachably to an adapter form fit element of the machine for electrical discharge machining. In a closed position of the adapter form fit elements, the dielectric inlet of the filter arrangement is fluid-tightly connected to the dielectric feed connection element. The adapter form fit elements permit the closed position only in a defined angle position, thereby determining a position of an identification element of the filter arrangement relative to the adapter form fit element of the machine for electrical discharge machining and of a corresponding reading device at the machine for electrical discharge machining relative to the an identification element.

### CROSS-REFERENCE TO RELATED APPLICATIONS

This application is a continuation application of international application No. PCT/EP2019/058337 having an international filing date of 3 Apr. 2019 and designating the United States, the international application claiming a priority date of 4 Apr. 2018 based on prior filed German patent application No. 10 2018 002 766.0, the entire contents of the aforesaid international application and the aforesaid German patent application being incorporated herein by reference.

### BACKGROUND OF THE INVENTION

The invention concerns a filter arrangement for a machine for electrical discharge machining, comprising at least one hollow cylindrical filter element configured for purifying a dielectric of the machine for electrical discharge machining and at least one dielectric inlet arranged centrally at an end face of the filter arrangement with at least one axial rotation-symmetrical connector for connecting a dielectric feed connection element of the machine for electrical discharge machining.

The invention concerns a connection interface element for a machine for electrical discharge machining, comprising at least one dielectric feed connection element that is configured to connect a dielectric feed element, in particular at least one feed line, for example at least one hose, of the machine for electrical discharge machining to a connector of a filter arrangement configured to purify a dielectric of the machine for electrical discharge machining, wherein the dielectric feed connection element is arranged centrally at the connection interface element.

The invention concerns a filter interface unit for a machine for electrical discharge machining, characterized by a filter arrangement as described above and a connection interface element of the machine for electrical discharge machining as described above.

The prior art, for example, DE 20 2005 014 690 U1, disclose filters with filter elements, flowed through from the interior to the exterior, for machines for electrical discharge machining (EDM). Machines for electrical discharge machining are machines which are used in tool and mold construction. Filters for machines for electrical discharge machining filter the processing liquid or the dielectric, mostly deionized water but sometimes also electrical discharge machining oil. Due to the electrical discharge machining process, steel particles are contained in the dielectric and are filtered out by means of the filter. The purified dielectric is located in a circuit and is returned to the electrical discharge machining process.

The filter elements comprise usually hollow cylindrically arranged filter media arrangements, for example, wound or folded in a star shape, which are flowed through from the interior to the exterior and are loaded with dirt from the electrical discharge machining process. The filter elements are certified up to a maximum permissible differential pressure and must not be operated above the latter because this may lead to various malfunctions. In case of a customer complaint, it is important to be able to backtrack the filter element as well as the previous conditions at which the filter element has been operated. This backtracking is done in the prior art by means of a printed-on manufacturing date and a factory code of the producing factory. Backtracking of the operating conditions at which the filter element has been operated is possible only with further investigations.

In the field of oil and lubricant filtration with exchangeable filters, differential pressure switches are known which indicate a possible surpassing of the differential pressure.

The publication DE 10 2013 216 853 A1 discloses a fluid filter element with a pressure sensor and a temperature sensor. These sensors are fastened to an end disk and are embodied as R[adio] F[requency] ID[entification] sensors. These RFID sensors require an interface, able to communicate across great distances, between the R[adio] F[requency] ID[entification] reading device and the R[adio] F[requency] ID[entification] transponder.

EP 1 844 838 A2 discloses a filter with a R[adio] F[requency] ID[entification] pressure sensor for measuring a trans-membrane differential pressure. This RFID sensor requires an interface which can communicate across great distances.

The invention has the object to further develop a filter arrangement of the aforementioned kind, a connection interface element of the aforementioned kind, as well as a filter interface unit of the aforementioned kind such that they are of a simple configuration, wherein the filter arrangement serves as an information carrier.

Especially, a connection interface known from the prior art, which is in principle suitable to connect the dielectric feed connection element of the machine for electrical discharge machining to the filter device in an arbitrary angle position, is to be further developed such that an angle-unique mounting of the connection interface is realized.

### SUMMARY OF THE INVENTION

This object is solved by a filter arrangement that is characterized in that:
at least one identification element comprising filter-specific data is fastened captively to the end face of the filter arrangement, wherein the identification element is arranged at a radial distance from the dielectric inlet, and
at the end face of the filter arrangement, at a radial distance from the dielectric inlet, at least one adapter form fit element is captively fastened, wherein, for connecting the filter arrangement to the machine for electrical discharge machining, the adapter form fit element of the filter arrangement is connectable detachably to an adapter form fit element of the machine for electrical discharge machining, wherein, in a closed position of the adapter form fit elements, the axial dielectric inlet of the filter arrangement is fluid-tightly connectable to the dielectric feed connection element of the machine for electrical discharge machining, and wherein the adapter form fit element of the filter arrangement is configured such that it permits the closed position of the respective adapter form fit elements only in a defined angle position and in this way determines the position of the identification element relative to the adapter form fit element of the machine for electrical discharge machining.

This object is solved by a connection interface element that is characterized by:
at least one reading device configured to read contactless data of at least one identification element of the filter arrangement, in particular at least one R[adio] F[requency] ID[entification] reader, wherein the reading device is arranged at a radial distance from the dielectric feed connection element, and
at least one adapter form fit element arranged at a radial distance from the dielectric feed connection element, wherein the adapter form fit element of the machine for electrical discharge machining is configured to enable the connection of the machine for electrical discharge machining to the filter arrangement, wherein the adapter form fit element of the filter arrangement is detachably connectable to the adapter form fit element of the machine for electrical discharge machining, wherein in a closed position of the adapter form fit elements the dielectric feed connection element of the machine for electrical discharge machining is connectable fluid-tightly to an axial dielectric inlet of the filter arrangement, wherein the adapter form fit element of the machine for electrical discharge machining is configured as a counterpart to the adapter form fit element of the filter arrangement, and wherein the adapter form fit element of the machine for electrical discharge machining is embodied such that it permits the closed position of the respective adapter form fit elements only in a defined angle position and in this way determines the position of the reading device relative to the adapter form fit element of the filter arrangement.

This object is solved by a filter interface unit characterized by a filter arrangement as characterized above and the connection interface element of the machine for electrical discharge machining as characterized above.

Advantageous embodiments and expedient further developments of the present invention are characterized in the respective dependent claims.

Thus, the present invention is based on the filter arrangement comprising at least one adapter form fit element. This adapter form fit element of the filter arrangement is configured to enable the connection of the filter arrangement to an adapter form fit element of the machine for electrical discharge machining which is embodied as a counterpart to the adapter form fit element of the filter arrangement. In order to enable an angle-unique mounting of the dielectric feed connection element of the machine for electrical discharge machining at the filter arrangement, the dielectric feed connection element can be connected to the filter arrangement only when the adapter form fit element of the filter arrangement and the adapter form fit element of the machine for electrical discharge machining are engaging each other.

The present invention is based in particular on providing for a rotation-symmetrical connection interface at least one adapter form fit element correlated with the filter arrangement and at least one adapter form fit element correlated with the machine for electrical discharge machining, wherein the adapter form fit elements permit closing of the connection interface only in a defined angle position.

In other words, the adapter form fit element of the filter arrangement is configured to interact with the adapter form fit element of the machine for electrical discharge machining such that the closure of the adapter form fit elements can be realized only in a defined angle position of the adapter form fit elements.

The adapter form fit element of the filter arrangement is arranged at a radial distance from a dielectric inlet of the filter arrangement. The adapter form fit element of the filter arrangement is thus arranged eccentrically relative to the dielectric inlet. The term “radial” relates in this context to the longitudinal axis of the filter arrangement. The adapter form fit element of the filter arrangement is thus eccentrically arranged relative to the longitudinal axis of the filter arrangement.

For connecting a dielectric feed connection element of the machine for electrical discharge machining, the dielectric inlet of the filter arrangement comprises at least one axial rotation-symmetrical connector. The axial rotation-symmetrical connector of the dielectric inlet can be, for example, an axial hose connection extension, for example, with a thread.

In order to serve as an information carrier, the filter arrangement comprises at least one identification element containing filter-specific data. As filter specific data, the identification element can comprise, for example, the following data:
manufacturing date and/or manufacturing factory of the filter arrangement and/or
manufacturing batch of the filter element or of other function-relevant parts and/or
datasheet of the filter element with characteristic data such as nominal volume flow per maximum differential pressure and/or
installation instructions for the filter arrangement and/or
instructions for the use of attachment parts such as grips or the like.

The identification element is arranged eccentrically relative to the dielectric inlet.

The identification element can be embodied, for example, as Q[uick] R[esponse] C[ode] or can comprise at least one Q[uick] R[esponse] C[ode].

In addition to the Q[uick] R[esponse] C[ode] or as an alternative to the Q[uick] R[esponse] C[ode], the identification element can comprise, for example, at least one memory element embodied for storing filter-specific data or at least one memory chip embodied for storing filter-specific data.

The memory chip can be embodied to receive and to store data from at least one sensing element embodied for measuring filter-specific data, for example, from a pressure sensor. The sensing element or sensor can measure the filter-specific data piezoelectrically, for example. Alternatively, a pressure measurement can also take place at the machine for electrical discharge machining.

Moreover, the identification element can comprise at least one transponder embodied for receiving and relaying the filter-specific data, in particular a R[adio] F[requency] ID[entification] transponder. By means of this RFID transponder, a data exchange with an RFID reading device correlated with the machine for electrical discharge machining can be performed.

For example, the memory chip can be connected by means of the R[adio] F[requency] ID[entification] transponder to the control unit of the machine for electrical discharge machining. A memory chip which communicates with a pressure sensor as well as with the control unit of the machine for electrical discharge machining can automatically lead to, for example, switching off the filter arrangement and/or the machine for electrical discharge machining when a defined differential pressure is reached.

In an advantageous embodiment of the filter interface unit of the present invention, the connection interface element of the filter arrangement and the connection interface element of the machine for electrical discharge machining not only serve to connect the dielectric feed connection element of the machine for electrical discharge machining to the filter arrangement but also as a junction between the identification element of the filter arrangement and the reading device of the machine for electrical discharge machining, wherein the exchange of filter-specific data and/or of filter-specific control signals is realized at this junction.

The adapter form fit element of the filter arrangement enables precise fit mounting of the identification element arranged eccentrically relative to the dielectric inlet in relation to the dielectric feed connection element of the machine for electrical discharge machining, in particular in relation to at least one reading device which is arranged eccentrically at the dielectric feed connection element, for example, in relation to at least one R[adio] F[requency] ID[entification] reading device arranged eccentrically at the dielectric feed connection element.

In a particularly advantageous embodiment of the present invention, the adapter form fit element of the filter arrangement thus determines the position of a R[adio] F[requency] ID[entification] reading device of the machine for electrical discharge machining above a R[adio] F[requency] ID[entification] memory element, in particular above a R[adio] F[requency] ID[entification] transponder, of the filter arrangement. By means of an angle-unique mounting of the adapter form fit element, it can be ensured, for example, that in the closed position of the connection interface or of the dielectric feed connection element a R[adio] F[requency] ID[entification] reading device correlated with the machine for electrical discharge machining is precisely positioned above a R[adio] F[requency] ID[entification] transponder of the filter arrangement.

The filter arrangement is advantageously embodied such that the dielectric to be purified flows radially from the interior to the exterior through the filter element.

In order to enable a particularly simple mounting of the identification element as well as of the adapter form fit element of the filter arrangement, the identification element, the dielectric inlet, and the adapter form fit element of the filter arrangement are advantageously correlated with a connection interface element of the filter arrangement arranged centrally at an end face of the filter arrangement.

For covering an end face of the filter element, the filter arrangement advantageously comprises at least one end disk. For facilitating mounting of the connection interface element, the latter is advantageously fastenable captively at the end disk by means of at least one, in particular form-fit, connector, for example, by means of at least one snap connection or at least one clip connection.

In an advantageous embodiment of the present invention, the adapter form fit element comprises an areal elevation which extends away from the filter element. The end face of the adapter form fit element of the filter arrangement is thus advantageously arranged axially displaced relative to the end face of the filter element of the filter arrangement or the end face of the end disk.

In order to enable a particularly precise positioning, advantageously at least one additional axial positioning geometry, in particular at least one axial geometric elevation extending away from the filter element, is arranged at the end face of the adapter form fit element of the filter arrangement. This axial positioning geometry can have an arbitrary geometry, for example, at least one letter and/or at least one mathematical character and/or at least one geometric shape, such as a star or a triangle.

The axial positioning geometry of the adapter form fit element of the filter arrangement is advantageously embodied to interact with an axial positioning geometry of the adapter form fit element of the machine for electrical discharge machining embodied as a cutout in such a way that in the closed position of the respective adapter form fit elements the positioning geometry of the filter arrangement projects through the positioning geometry of the machine for electrical discharge machining and can be felt from the exterior side of the filter arrangement. In this context, the positioning geometry of the adapter form fit element of the filter arrangement and the positioning geometry of the adapter form fit element of the machine for electrical discharge machining are embodied as counterparts relative to each other. The axial positioning geometry of the adapter form fit element can be, for example, a completely cutout opening, for example, a completely cutout logotype.

In other words, the adapter form fit element of the filter arrangement advantageously has an axial elevation wherein, on this elevation, there is still furthermore a somewhat raised portion that, in the closed position of the adapter form fit elements, projects through the axial positioning geometry of the adapter form fit element of the machine for electrical discharge machining and can be felt at the side which is facing away from the filter element. In this way, the user can check by feeling, for example, whether the closed position of the adapter form fit elements has been reached.

Feeling the positioning geometry of the adapter form fit element of the filter arrangement in the closed position of the adapter form fit element is achieved in that the raised portion of the axial positioning geometry of the adapter form fit element of the filter arrangement is larger than the axial displacement path of the respective adapter form fit element for arranging the adapter form fit element in the closed position or for mutual engagement of the adapter form fit elements. In other words, the raised portion of the axial positioning geometry of the adapter form fit element of the filter arrangement is larger than the locking clearance of the adapter form fit elements.

In an advantageous embodiment of the filter interface unit of the present invention, the identification element, the dielectric inlet, and the adapter form fit element of the filter arrangement are correlated with a connection interface element of the filter arrangement arranged centrally at the end face of the filter arrangement. Moreover, the adapter form fit element of the machine for electrical discharge machining is correlated with a connection interface element of the machine for electrical discharge machining.

The connection interface element of the filter arrangement and the connection interface element of the machine for electrical discharge machining are respectively embodied to lock at each other by an axial displacement along a defined displacement path. This axial displacement along a defined displacement path can also be referred to as locking clearance. Locking of the respective connection interface elements is possible only when the adapter form fit element of the filter arrangement and the adapter form fit element of the machine for electrical discharge machining engage each other and are thus arranged in a defined angle position. In other words, the connection interface element of the machine for electrical discharge machining can only be connected when the adapter form fit element of the filter arrangement and the adapter form fit element of the machine for electrical discharge machining engage each other.

### BRIEF DESCRIPTION OF THE DRAWINGS

As has already explained above, there are various possibilities to embody and further develop the teachings of the present invention in an advantageous manner. In this context, on the one hand, reference is being had to the dependent claims; on the other hand, further embodiments, features, and advantages of the present invention will be explained in more detail in the following inter alia with the aid of an embodiment illustrated in FIGS. 1 through 6.

FIG. 1 shows in schematic illustration an embodiment of a filter interface unit according to the present invention with an embodiment of a filter arrangement according to the present invention.

FIG. 2 shows in isometric side view (=left half of FIG. 2) as well as in schematic longitudinal section (=right half of FIG. 2) the filter interface unit of FIG. 1.

FIG. 3 shows in perspective illustration a top view of the filter arrangement of FIG. 1.

FIG. 4 shows in perspective illustration a side view of the filter interface unit of FIG. 1.

FIG. 5 shows in schematic longitudinal section illustration the filter interface unit of FIG. 1, wherein the adapter form fit elements are arranged in an open position, i.e., are not engaging each other.

FIG. 6 shows in an angled section illustration the filter interface unit of FIG. 1, wherein the adapter form fit elements are arranged in a closed position, i.e., are engaging each other.

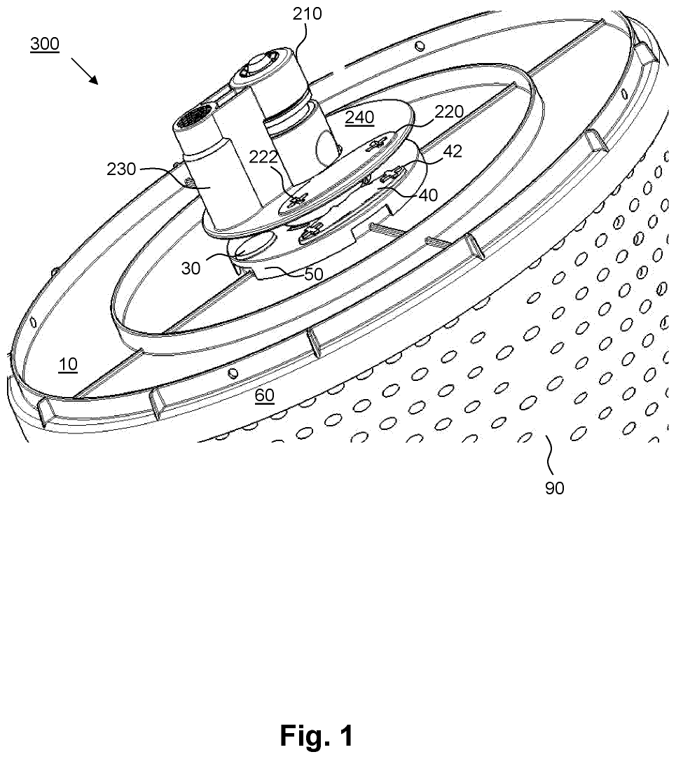

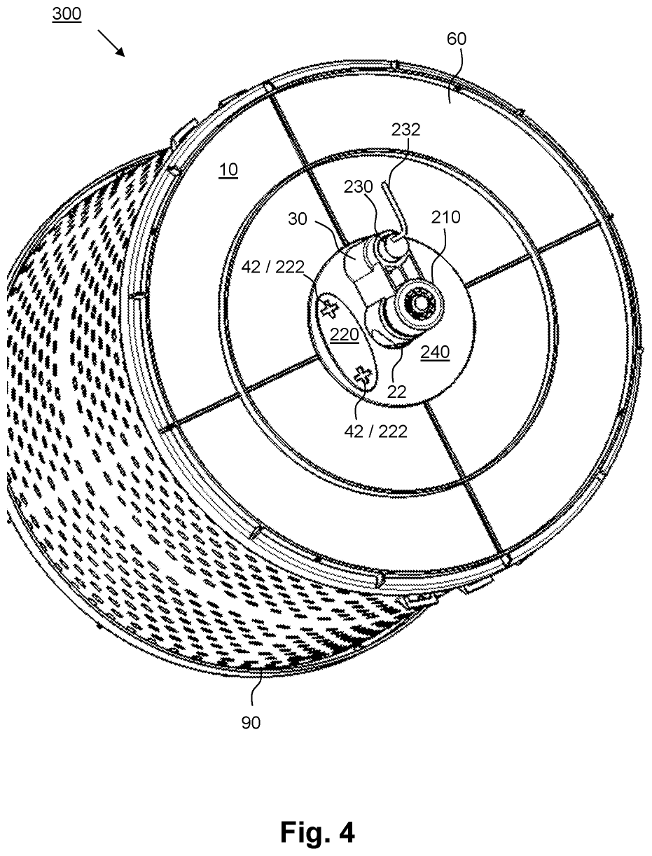

Same or similar embodiments, elements or features are provided in FIGS. 1 to 6 with identical reference characters.

### DESCRIPTION OF PREFERRED EMBODIMENTS

In the embodiment of the present invention illustrated with the aid of FIGS. 1 to 6, a filter interface unit 300 with a filter arrangement 100 as well as with a connection interface element 240 of the machine for electrical discharge machining is illustrated.

The filter arrangement 100 comprises a hollow cylindrical liquid filter element 80 embodied for purifying a dielectric of a machine for electrical discharge machining and comprising a dielectric inlet 20 centrally arranged at an end face 10 of the filter arrangement 100. The dielectric inlet 20 is correlated with a connection interface element 50 of the filter arrangement 100.

For connecting the filter arrangement 100 to the machine for electrical discharge machining, the dielectric inlet 20 has an axial rotation-symmetrical connector 22. As illustrated in FIG. 1, the axial rotation-symmetrical connector 22 can be, for example, a hose connector or a hose quick coupling. This hose connector or this hose quick coupling can be configured in a way as is known in the prior art, for example, for garden hoses.

Thus, the axial rotation-symmetrical connector 22 can comprise a collar which is engaged by a locking element. The axial rotation-symmetrical connector 22 can be embodied, for example, as an annular extension at which a hose coupling can engage. As an alternative to a standard hose connector, the axial rotation-symmetrical connector 22 can be axially clamped. Instead of a hose connector 22, the filter arrangement 100 then has an axial seal. In this context, a flange or a pipe is arranged at the machine for electrical discharge machining that projects into the filter arrangement 100 and is then axially clamped.

The connection interface element 240 of the machine for electrical discharge machining comprises a dielectric feed connection element 210 connected to a dielectric feed element, for example, a hose. This dielectric feed connection element 210 is embodied as a counterpart 210 to the axial rotation-symmetrical connector 22 of the filter arrangement 100. The dielectric feed connection element 210 is thus advantageously a hose connector element or a hose quick coupling element as is known from the prior art, for example, for garden hoses. The hose can thus be adapted by means of a quick coupling 22, 210 to the liquid filter element. The hose can comprise, for example, a diameter of 13 inches or 19 millimeter (mm).

The connection interface element 240 of the machine for electrical discharge machining can thus be a conventional hose connection adapter wherein, externally about the hose connection adapter, a surface, for example, of plastic material, is arranged and on this surface an RFID reader and an adapter form fit element are arranged.

The filter element 80 illustrated in FIG. 1 is relatively large. For example, the filter element 80 can have a diameter of approximately 340 mm and a height of approximately 300 mm. The filter arrangement 100 is a so-called “stand alone filter” which requires no pressure container at the device. In this context, a fluid-permeable support body 90 that is arranged axially outwardly about the filter element 80 absorbs the complete differential pressure. The support body 90 can be, for example, an outer jacket 90 provided with fluid passage openings, for example, a perforated sheet metal or a plastic housing comprising cutout holes.

At the end faces of the filter arrangement, a respective end disk 60 is arranged. These end disks 60 support the support body 90 and ensure a pressure stability of the filter arrangement 100.

The dielectric flows via the fluid connector 20, 22, 210 into the filter arrangement 100 and flows through the filter bellows 80 from the interior to the exterior. With increasing load state, i.e., with increasing amount of collected steel particles in the filter bellows 80, the differential pressure of the filter arrangement 100 increases. The differential pressure is absorbed by the outer jacket 90. At a defined differential pressure, for example, at 3.0 bar, the filter arrangement 100 is completely exchanged. The filter bellows 80 is not exchangeable. The complete filter arrangement 100, which, for example, is surrounded by a plastic housing, is removed from the machine for electrical discharge machining and disposed of.

At an end face 10 of the filter arrangement 100, an identification element 30, for example, a R[adio] F[requency] ID[entification] chip and/or a R[adio] F[requency] ID[entification] transponder is arranged fixedly at the filter. The identification element 30 stores filter-specific data which it obtains, for example, from a measuring element, for example, a pressure sensor. The filter arrangement illustrated in FIGS. 1 to 6 can thus be, for example, an E[lectrical] D[ischarge] M[achining] filter with a R[adio] F[requency] ID[entification] chip and a pressure sensor that can be read out contactless.

The identification element 30 is arranged at a radial distance from the dielectric inlet 20.

The identification element 30 assigns a unique ID[entification] to the filter element 80. Thus, the identification element 30 stores, for example, information in regard to how the filter element 80 is to be operated, how inflow at the filter element 80 is to be provided, and/or up to which differential pressure inflow to the filter element 80 is possible. The information stored by the identification element 30 can contain, for example, information for the machine for electrical discharge machining and/or for the end user. The identification element 30 is located in a receiving element 32, namely in an axial elevation, of the connection interface element 50 of the filter arrangement 100. The identification element 30 can be designed, for example, in a disk shape and can have a diameter, for example, of approximately 16 mm to 20 mm.

For reading out the identification element 30, the connection interface element 240 of the machine for electrical discharge machining comprises at least one reading device 230 that is embodied for contactless reading or reading out the data of the identification element 30 of the filter arrangement 100, for example, a R[adio] F[requency] ID[entification] reader. In this context, a precise positioning of the reading device 230 in relation to the identification element 30 is a prerequisite for the identification element 30 to be recognized or read out by the reading device 230. The reading device 230 is connected to the machine for electrical discharge machining.

In order to determine the position of the identification element 30 relative to the reading device 230, the connection interface element 50 of the filter arrangement 100 and the connection interface element 240 of the machine for electrical discharge machining each have an adapter form fit element 40 and 220, respectively. These adapter form fit elements 40 and 220 are detachably connectable to each other and are embodied as counterparts relative to each other. The adapter form fit elements 40 and 220 are arranged eccentrically at the connection interface element 50, respectively, 240 and enable thus the closure of the connection interface elements 50 and 240 only in one defined angle position.

The filter arrangement 100 illustrated in FIGS. 1 to 6 comprises thus a fluid connector 20, 22, 210 that is embodied like a garden hose connector. This fluid connector 20, 22, 210 is embodied essentially with rotational symmetry, can thus be connected in an arbitrary angle position.

Adapter form fit elements 40 and 220, arranged eccentrically to the fluid connector 20, 22, 210, are provided at the connection interface elements 50 and 240, respectively. These adapter form fit elements 40 and 220 can have, for example, a raised structure at the filter side and a recessed structure at the machine side, respectively.

Upon connection of the connection interface elements 50 and 240, the reading device 230 is positioned with the fluid connector 210 precisely above the identification element 30 by means of the adapter form fit elements 40 and 220. In this context, the adapter form fit elements 40 and 220 are embodied such that the fluid connector 20, 22, 210 can be connected only when the two form fit elements 40 and 220 are engaging each other.

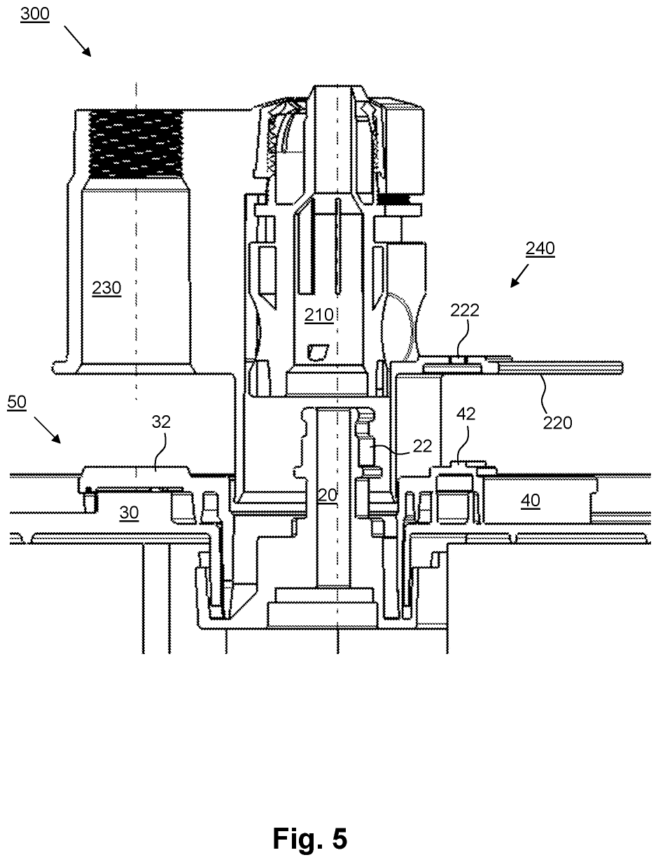

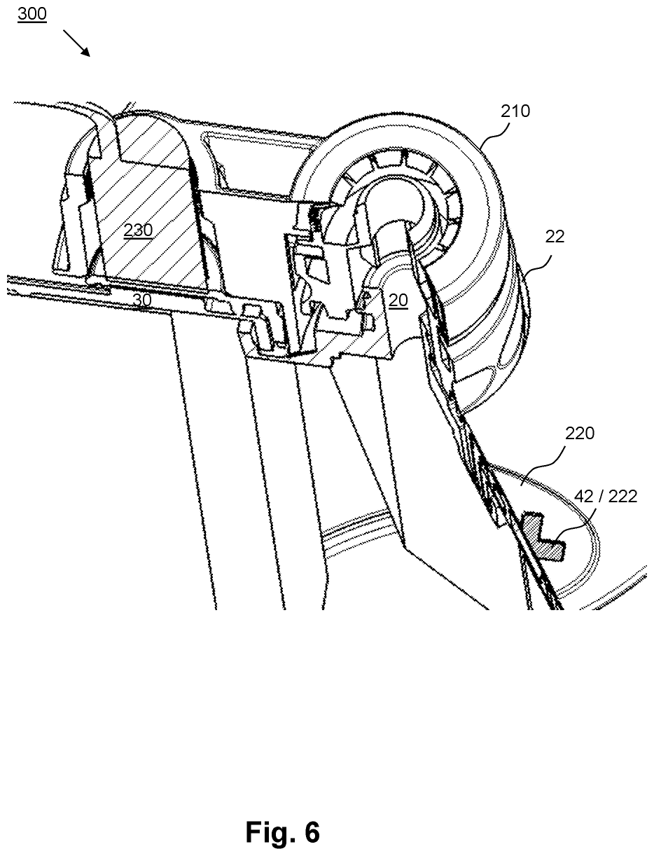

FIGS. 5 and 6 show schematically the features of the fluid connector with the dielectric inlet 20, the connector 22 of the filter arrangement 100, and the dielectric feed connection element 210 of the machine for electrical discharge machining. In FIG. 5, a first position is illustrated in which the positioning geometry of the adapter form fit elements are not yet engaging each other. In this position, the fluid connector 20, 22, 210 is not yet in engagement and the reading device 230 is not arranged above the identification element 30.

FIG. 6 shows a second position, namely the position of use or final position of the filter arrangement 100. In this position of use, the adapter form fit elements 40, 220 engage each other with form fit and the fluid connector 20, 22, 200 closes; fluid connector and coupling are thus in engagement and seal-tight.

### LIST OF REFERENCE CHARACTERS

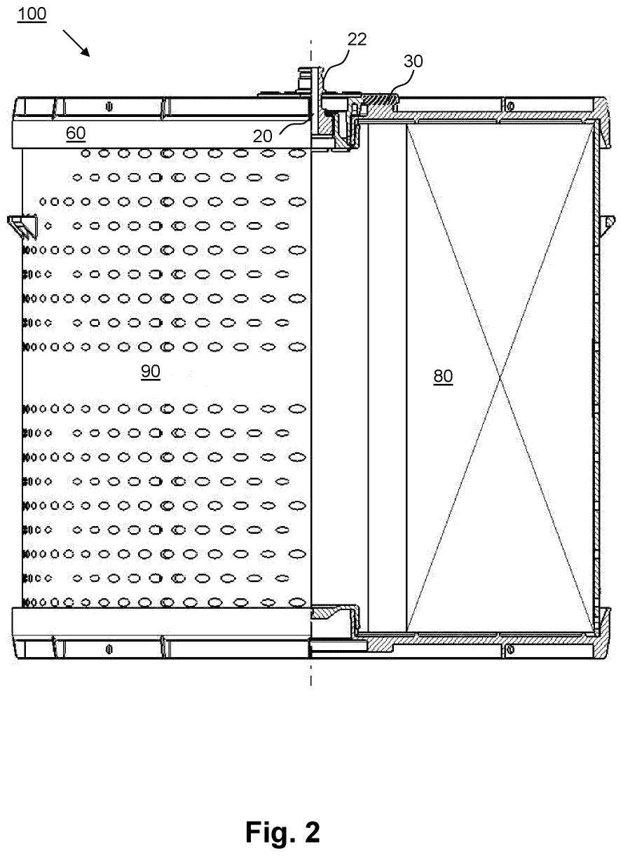

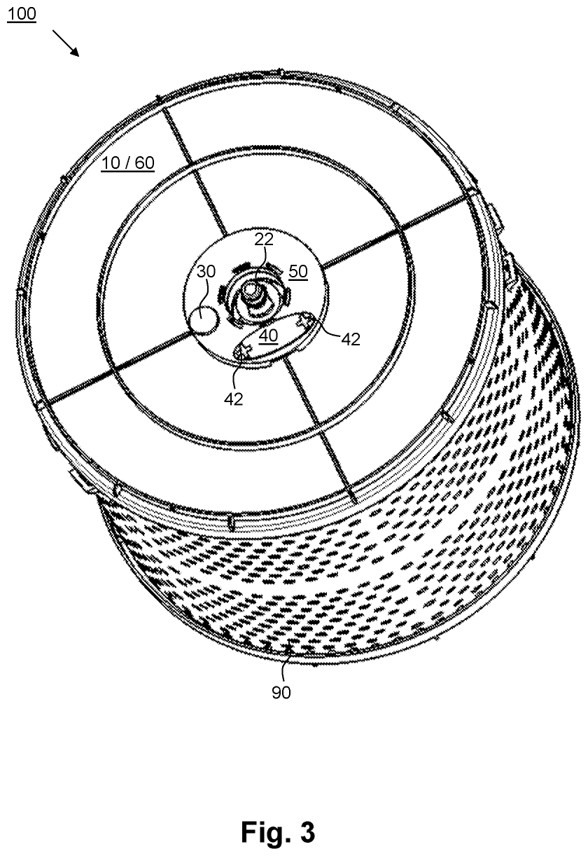

10 end face of the filter arrangement 100
20 dielectric inlet, in particular fluid connector
22 axial rotation-symmetrical connector of the dielectric inlet 20, in particular hose connector or hose quick coupling
30 identification element, in particular memory element and/or transponder, for example, R[adio] F[requency] ID[entification] transponder or Q[uick] R[esponse] C[ode]
32 receiving element, configured for receiving the identification element 30, in particular axial elevation, of the connection interface element 50 of the filter arrangement 100 (compare FIG. 5)
40 adapter form fit element of the filter arrangement 100
42 positioning geometry of the adapter form fit element 40 of the filter arrangement 100, in particular axial geometric elevation, for example, at least one letter and/or at least one mathematical character and/or at least one geometric shape, for example, a star or a triangle, for example, raised positioning geometry
50 connection interface element of the filter arrangement 100, in particular filter-associated adapter
60 end disk
80 hollow cylindrical filter element, in particular liquid filter element, of the filter arrangement 100, for example, filter bellows
90 fluid-permeable support body or outer jacket of the filter arrangement 100, in particular perforated sheet or support grid, arranged about the filter arrangement 100
100 filter arrangement (compare FIGS. 2 and 3)
210 dielectric feed connection element, in particular connector, for example, fluid adapter, for example, fluid connector or fluid coupling
220 adapter form fit element of the machine for electrical discharge machining
222 positioning geometry of the adapter form fit element 220 of the machine for electrical discharge machining, in particular cutout positioning geometry
230 reading device, in particular R[adio] F[requency] ID[entification] reading device or R[adio] F[requency] ID[entification] reader, for example, read and/or write head for the R[adio] F[requency] ID[entification] transponder 30
232 connection cable of the reading device 230 for connecting the reading device 230 to the machine for electrical discharge machining, in particular to at least one control element of the machine for electrical discharge machining
240 connection interface element of the machine for electrical discharge machining, in particular machine-associated adapter
300 filter interface unit for a machine for electrical discharge machining

What is claimed is:

1. A filter arrangement for a machine for electrical discharge machining, the filter arrangement comprising:
at least one hollow cylindrical filter element configured to purify a dielectric of the machine for electrical discharge machining;
at least one dielectric inlet arranged centrally at an end face of the filter arrangement, the at least one dielectric inlet comprising at least one axial rotation-symmetrical connector configured to connect a dielectric feed connection element of the machine for electrical discharge machining;
at least one identification element comprising filter-specific data, wherein the at least one identification element is fastened captively to the end face of the filter arrangement and arranged at a radial distance from the at least one dielectric inlet;
at least one adapter form fit element captively fastened to the end face of the filter arrangement at a radial distance from the at least one dielectric inlet;
wherein, for connecting the filter arrangement to the machine for electrical discharge machining, the at least one adapter form fit element of the filter arrangement is configured to connect detachably to an adapter form fit element of the machine for electrical discharge machining;
wherein, in a closed position of the at least one adapter form fit element of the filter arrangement and of the adapter form fit element of the machine for electrical discharge machining, the at least one axial dielectric inlet of the filter arrangement is configured to fluid-tightly connect to the dielectric feed connection element of the machine for electrical discharge machining;
wherein the at least one adapter form fit element of the filter arrangement is configured to permit said closed position only in a defined angle position and to determine thereby a position of the at least one identification element relative to the adapter form fit element of the machine for electrical discharge machining.

2. The filter arrangement according to claim 1, wherein the at least one identification element comprises at least one memory element configured to store the filter-specific data.

3. The filter arrangement according to claim 2, wherein the at least one identification element comprises at least one transponder configured to receive and relay the filter-specific data.

4. The filter arrangement according to claim 1, wherein the at least one identification element comprises at least one memory element configured to store the filter-specific data and at least one transponder configured to receive and relay the filter-specific data.

5. The filter arrangement according to claim 1, wherein the at least one axial rotation-symmetrical connector of the dielectric inlet is an axial hose connection extension.

6. The filter arrangement according to claim 1, further comprising a connection interface element arranged centrally at the end face of the filter arrangement, wherein the at least one identification element, the at least one dielectric inlet, and the at least one adapter form fit element of the filter arrangement are correlated with the connection interface element.

7. The filter arrangement according to claim 6, further comprising an end disk configured to cover a first end face of the at least one hollow cylindrical filter element, wherein the end disk is arranged at the end face of the filter arrangement, wherein the connection interface element is configured to be fastened captively to the end disk by at least one connection element.

8. The filter arrangement according to claim 7, wherein the at least one connection element is a snap connection element or a clip connection element.

9. The filter arrangement according to claim 1, wherein the at least one adapter form fit element of the filter arrangement comprises an end face facing away from the filter arrangement, wherein said end face of the at least one adapter form fit element of the filter arrangement is arranged axially displaced relative to the end face of the filter arrangement or relative to a surface of an end disk configured to cover an end face of the at least one hollow cylindrical filter element, wherein said surface is facing away from the filter arrangement.

10. The filter arrangement according to claim 9, wherein the end face of the at least one adapter form fit element of the filter arrangement comprises at least one axial positioning geometry.

11. The filter arrangement according to claim 10, wherein the at least one axial positioning geometry is an axial geometric elevation arranged at the end face of the at least one adapter form fit element of the filter arrangement and extending away from the at least one hollow cylindrical filter element.

12. The filter arrangement according to claim 11, wherein the axial geometric elevation is selected from the group consisting of a letter, a mathematical character, and a geometric shape.

13. A connection interface element for a machine for electrical discharge machining, the connection interface element comprising:
at least one dielectric feed connection element configured to connect a dielectric feed element of the machine for electrical discharge machining to a connector of a filter arrangement, configured to purify a dielectric of the machine for electrical discharge machining, wherein the at least one dielectric feed connection element is arranged centrally at the connection interface element;
at least one reading device configured to read contactless data of at least one identification element of the filter arrangement, wherein the at least one reading device is arranged at a radial distance from the at least one dielectric feed connection element;
at least one adapter form fit element arranged at a radial distance from the at least one dielectric feed connection element;
wherein the at least one adapter form fit element of the connection interface element is configured to enable a connection of the machine for electrical discharge machining to the filter arrangement and is configured as a counterpart to at least one adapter form fit element of the filter arrangement;
wherein the at least one adapter form fit element of the connection interface element is configured to detachably connect to the at least one adapter form fit element of the filter arrangement;
wherein, in a closed position of the at least one adapter form fit element of the connection interface element and of the at least one adapter form fit element of the filter arrangement, the at least one dielectric feed connection element is configured to connect fluid-tightly to an axial dielectric inlet of the filter arrangement;
wherein the at least one adapter form fit element of the connection interface element is configured to permit said closed position only in a defined angle position and to determine thereby a position of the at least one reading device relative to the at least one adapter form fit element of the filter arrangement.

14. A filter interface unit for a machine for electrical discharge machining, comprising:
a filter arrangement comprising:
at least one hollow cylindrical filter element configured to purify a dielectric of the machine for electrical discharge machining;
at least one dielectric inlet arranged centrally at an end face of the filter arrangement, the at least one dielectric inlet comprising at least one axial rotation-symmetrical connector;
at least one identification element comprising filter-specific data, wherein the at least one identification element is fastened captively to the end face of the filter arrangement and arranged at a radial distance from the at least one dielectric inlet;
at least one adapter form fit element captively fastened to the end face of the filter arrangement at a radial distance from the at least one dielectric inlet;
a connection interface element for the machine for electrical discharge machining, comprising:
at least one centrally arranged dielectric feed connection element configured to connect a dielectric feed element of the machine for electrical discharge machining to the at least one axial rotation-symmetrical connector of the filter arrangement;
at least one reading device configured to read contactless the filter-specific data of the at least one identification element of the filter arrangement, wherein the at least one reading device is arranged at a radial distance from the at least one centrally arranged dielectric feed connection element;
at least one adapter form fit element arranged at a radial distance from the at least one centrally arranged dielectric feed connection element, wherein the at least one adapter form fit element of the connection interface element for the machine for electrical discharge machining is configured as a counterpart to the at least one adapter form fit element of the filter arrangement;
wherein, for connecting the filter arrangement to the machine for electrical discharge machining, the at least one adapter form fit element of the filter arrangement is configured to connect detachably to the at least one adapter form fit element of the connection interface element for the machine for electrical discharge machining;
wherein, in a closed position of the at least one adapter form fit element of the filter arrangement and of the at least one adapter form fit element of the connection interface element for the machine for electrical discharge machining, the at least one axial dielectric inlet of the filter arrangement is configured to fluid-tightly connect to the at least one centrally arranged dielectric feed connection element of the connection interface element for the machine for electrical discharge machining;
wherein the at least one adapter form fit element of the filter arrangement and the at least one adapter form fit element of the connection interface element for the machine for electrical discharge machining are configured to permit said closed position only in a defined angle position and to determine thereby a position of the at least one identification element relative to the at least one adapter form fit element of the connection interface element for the machine for electrical discharge machining and to determine thereby a position of the at least one reading device relative to the at least one adapter form fit element of the filter arrangement.

15. The filter interface unit according to claim 14, wherein the filter arrangement further comprises a connection interface element arranged centrally at the end face of the filter arrangement, wherein the at least one identification element, the at least one dielectric inlet, and the at least one adapter form fit element of the filter arrangement are correlated with the connection interface element of the filter arrangement, wherein the connection interface element of the filter arrangement and the connection interface element for the machine for electrical discharge machining are configured to engage each other in a locking engagement by an axial displacement along a defined displacement path, wherein said locking engagement is possible only when the at least one adapter form fit element of the filter arrangement and the at least one adapter form fit element of the connection interface element for the machine for electrical discharge machining engage each other.

16. The filter interface unit according to claim 14, wherein, in the defined angle position, the at least one adapter form fit element of the filter arrangement and the at least one adapter form fit element of the connection interface element for the machine for electrical discharge machining determine a position of the at least one identification element relative to the at least one reading device.

17. The filter interface unit according to claim 14, wherein the at least one centrally arranged dielectric feed connection element of the connection interface element for the machine for electrical discharge machining is a hose connection element.

18. The filter interface unit according to claim 14, wherein the at least one adapter form fit element of the filter arrangement comprises an axial positioning geometry configured to interact with an axial positioning geometry, configured as a cutout, of the at least one adapter form fit element of the connection interface element for the machine for electrical discharge machining such that, in said closed position, the axial positioning geometry of the filter arrangement passes through the axial positioning geometry of the connection interface element for the machine for electrical discharge machining and can be felt from an exterior of the filter arrangement.
